(19) United States
(12) Patent Application Publication
(10) Pub. No.: US 2026/0226267 A1
(43) Pub. Date: Aug. 6, 2026

(54) WATER-BASED COMPOSITIONS COMPRISING LATEX AND PHOTOINITIATORS

(71) Applicant: Arkema Inc., King of Prussia, PA (US)

(72) Inventors: Yuk Mun LI, King of Prussia, PA (US); Mary C. CHERVENAK, King of Prussia, PA (US); Mike B. ANDERSON, King of Prussia, PA (US); Jeanne L. STALLINGS, King of Prussia, PA (US); Richard PLENDERLEITH, King of Prussia, PA (US); Hannah YOUNG, King of Prussia, PA (US)

(21) Appl. No.: 19/153,983

(22) PCT Filed: Feb. 6, 2024
(86) PCT No.: PCT/US2024/014582

§ 371 Date: Aug. 6, 2025

Related U.S. Application Data
(60) Provisional application No. 63/444,603, filed on Feb. 10, 2023.

(51) Int. Cl. C08L 51/00; C08F 2/50; C08F 265/06; C09D 5/02; C09D 7/65; C09D 151/00; C09J 151/00

(52) U.S. Cl. CPC C08L 51/003; C08F 2/50; C08F 265/06; C09D 5/02; C09D 7/65; C09D 151/003; C09J 151/003; C08L 2201/52; C08L 2201/54

(57) ABSTRACT

A water-based composition may include a latex polymer having a T_{g} from about −50° C. to about 20° C., or from about −20° C. to 20° C., or from about 0° C. to 20° C., or from about 5° C. to 20° C., or from about 8° C. to 14° C. and a photoinitiator component including a Norrish type I photoinitiator and a Norrish type II photoinitiator, and optionally a crosslinking component, and optionally a siloxane-based block resistance additive. The water-based composition does not contain benzophenone and does not contain methyl-o-benzoyl benzoate.

### TECHNICAL FIELD

Embodiments of the present disclosure generally relate to water-based compositions, and more specifically to water-based compositions comprising latex and photoinitiators, and the use of such water-based compositions.

### BACKGROUND

Conventional water-based compositions have used compounds, such as benzophenone, to improve the durability and dirt pickup resistance of the compositions when utilized in coating applications, such as when utilized as a paint. However, benzophenone is a volatile organic compound (VOC) which over time is released from the water-based composition into the surrounding environment. Methyl-o-benzoyl-benzoate (“MBB”) may be an acute and chronic aquatic toxin. It is desired to reduce the use of benzophenone in water-based compositions to limit exposure to the harmful emissions from the release of benzophenone into the environment. Accordingly, there is a need for water-based compositions that have desirable physical properties, but that do not contain benzophenone or methyl-o-benzoyl-benzoate.

U.S. Pat. No. 9,120,936 discloses a water based composition containing a low VOC coalescent, a latex or water-dispersible polymer, and a water-insoluble ultraviolet absorber. The water based composition may contain benzophenone as the water-insoluble ultraviolet absorber.

U.S. Pat. No. 9,822,275 discloses water-based compositions containing a low VOC coalescent, a latex or water-dispersible polymer, and a water-insoluble ultraviolet-visible absorber. The water-insoluble ultraviolet-visible absorber may be benzophenone.

U.S. Pat. No. 10,196,537 discloses water-based compositions that are resistant to dirt pickup, efflorescence, tannin bleed-through and surfactant leaching. The water-based compositions include a latex or water-dispersible polymer and a non-VOC ultraviolet-visible absorber as a dirt pickup resistance additive. Methods of making the water-based compositions are also disclosed.

PCT patent application No. 2019232051 discloses water-based coating compositions or paint having improved gloss retention, including a latex or water-dispersible polymer, a ultraviolet-visible absorber comprising a substituted benzophenone capable of being a free radical generator, a hindered amine light stabilizer, and optionally a low-VOC coalescent provided in a preferably desired amount. Gloss retention of the paints containing the UV-VIS absorber and hindered amine light stabilizer was improved over paints that do not have both components.

Bartkowiak, M, et al., “Photoreactive UV-Crosslinking Acrylic Pressure-Sensitive Adhesives (PSA) Containing Multifunctional Photoinitiators”, Polymers, 2021, 13, 441 discusses the use of ultraviolet radiation technology for the crosslinking of acrylic pressure sensitive adhesives. The activity of multifunctional saturated photoinitiators of Norrish type I and type II in photoreactive UV-crosslinkable acrylic PSA was also examined.

### SUMMARY

According to one or more embodiments of the present disclosure a water-based composition may comprise a latex polymer having a T_{g} from about T_{g} from about −50° C. to about 20° C., or from about −20° C. to 20° C., or from about 0° C. to 20° C., or from about 5° C. to 20° C., or from about 8° C. to 14° C. The water-based composition may also comprise a photoinitiator component comprising a Norrish type I photoinitiator and a Norrish type II photoinitiator. The water-based composition may optionally comprise a crosslinking component, and may optionally comprise a siloxane-based block resistance additive. The water-based composition does not contain benzophenone and does not contain methyl-o-benzoyl benzoate which corresponds to the following compound:

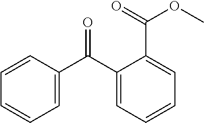 [SMILES: COC(=O)c1ccccc1C(=O)c1ccccc1]

The water-based compositions of the invention are equally or better performing than comparable products, by providing, for example, latexes, coatings, and paints that are capable of maintaining cleaner, more durable exterior surfaces with better weather resistance. By providing high levels of dirt-resistance (i.e., resistance to pick up of environmental dirt), products made using the water-based compositions of the invention, maintain an aesthetically pleasing film appearance and have an extended life. The water-based compositions of the invention and latex, coatings, and paint products made therewith also have enhanced long term gloss retention without the use of benzophenone and/or methyl-o-benzoyl benzophenone. The novel photoinitator system of the invention preferably is a liquid which facilitates ease of use in manufacturing. As a result, the water-based compositions of the invention provide better performing product(s) with reduced possible toxicity and are better for the environment.

### DETAILED DESCRIPTION

### Definitions

Unless otherwise stated the following terms have the meaning as provided below.

As used herein, the term “comprises a” may mean “comprises one or more”.

Unless otherwise mentioned, the weight percentages in a compound or a composition are expressed relative to the weight of the compound, respectively of the composition.

The term “hydrocarbyl” means a monovalent hydrocarbon, in which each hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more substituents, or unsubstituted. In this disclosure, hydrocarbyl may be an unsubstituted or substituted alkyl, an unsubstituted or substituted cycloalkyl, or an unsubstituted or substituted aryl.

The term “aryl” means an optionally substituted polyunsaturated aromatic group. The aryl may contain a single ring (i.e. phenyl) or more than one ring wherein at least one ring is aromatic. When the aryl comprises more than one more ring, the rings may be fused, linked via a covalent bond (for example biphenyl). The aromatic ring may optionally comprise one to two additional fused rings (i.e. cycloalkyl, heterocycloalkyl or heteroaryl). Examples include phenyl, naphthyl, biphenyl, phenanthrenyl and naphthacenyl.

The term “alkyl” means a monovalent saturated acyclic hydrocarbon group of formula —CₙH₂ₙ₊₁ wherein n is 1 to 20. An alkyl may be linear or branched. Examples of alkyl groups include methyl, ethyl, propyl, isopropyl, butyl, isobutyl, tert-butyl, pentyl, hexyl, 2-methylbutyl, 2,2-dimethylpropyl, n-hexyl, 2-methylpentyl, 2,2-dimethylbutyl, n-heptyl, 2-ethylhexyl, and the like.

The term “cycloalkyl” means a monovalent saturated alicyclic hydrocarbon group comprising a cycle. Examples of cycloalkyl groups include cyclopentyl, cyclohexyl, and isobornyl, any of which may be substituted or unsubstituted.

The term “heterocycloalkyl” means a cycloalkyl having at least one ring atom that is a heteroatom selected from O, N, or S.

The term “ethylenically unsaturated monomer” means a compound that includes a polymerizable carbon-carbon double bond (—C═C—). A polymerizable carbon-carbon double bond is a carbon-carbon double bond that can react with another carbon-carbon double bond in a polymerization reaction. A polymerizable carbon-carbon double bond is generally comprised in an acryloyl (—C(═O)—CH═CH₂), methacryloyl (—C(═O)—C(CH₃)═CH₂) or vinyl (—CH═CH₂) group. The carbon-carbon double bonds of an aromatic ring are not considered as polymerizable carbon-carbon double bonds.

The term “(meth)acrylate” means a compound bearing a (meth)acrylate group. The term “acrylate group” means an acryloyloxy group (—O—C(═O)—CH═CH₂). The term “methacrylate group” means a methacryloyloxy group (—O—C(═O)C(CH₃)═CH₂).

The term “alkyl (meth)acrylate” means an alkyl ester of (meth)acrylic acid.

The term “C1-C12 alkyl (meth)acrylate” means an alkyl ester of (meth)acrylic acid wherein the alkyl group bears from 1 to 12 carbon atoms.

The term “vinyl ester” means a vinyl ester of a saturated carboxylic acid. Said vinyl ester is preferably a vinyl ester of a C2-C20 saturated carboxylic acid.

The term “vinyl aromatic” means a compound that contains a carbon-carbon double bond in alpha position to an optionally substituted aromatic ring. Examples of aromatic rings include optionally substituted rings selected from benzene, toluene, xylene, biphenyl, indene, naphthalene, anthracene and mixtures thereof.

The term “acidic monomer” means an ethylenically unsaturated monomer bearing an acidic group (i.e. a group that can be anionised through loss of a proton) or a salt thereof. Said acidic group may be selected from a carboxylic acid (—COOH) group, a carboxylate (—COO⁻) group, a phosphonic acid (—P(═O)(OH)₂) group, a phosphonate (—P(═O)(OR)₂) group, a sulfonic acid (—S(═O)₂OH) group, a sulfonate (—S(═O)₂OR) group and a phosphate (—O—P(═O)(OR)₂) group, wherein each R is independently a counterion, a hydrogen atom, or an optionally substituted hydrocarbyl.

The term “functionalized monomer” means an ethylenically unsaturated compound bearing at least one functional group selected from hydroxyl, epoxy, carbonyl, a nitrogen-containing functional group and combinations thereof.

The term “hydroxylated (meth)acrylate” means (meth)acrylate functionalized with a hydroxyl group. Examples of hydroxylated (meth)acrylates include hydroxyalkyl (meth)acrylates, monohydroxylated polyether (meth)acrylates or monohydroxylated polyester (meth)acrylates.

The term “hydroxyalkyl (meth)acrylate” means an alkyl ester of (meth)acrylic acid, wherein the alkyl is substituted by a hydroxy group. Examples of hydroxyalkyl (meth)acrylates include 2-hydroxyethyl (meth)acrylate, 2-hydroxypropyl (meth)acrylate, 3-hydroxypropyl (meth)acrylate, 4-hydroxybutyl (meth)acrylate and mixtures thereof.

The term “monohydroxylated polyether (meth)acrylate” means a (meth)acrylate comprising a polyether chain terminated by a hydroxyl group. Examples of monohydroxylated polyether (meth)acrylates include a di-, tri-, tetra- or polyethylene glycol mono(meth)acrylate, a di-, tri-, tetra- or polypropylene glycol mono(meth)acrylate, a di-, tri-, tetra- or polybutylene glycol mono(meth)acrylate and mixtures thereof.

The term “monohydroxylated polyester (meth)acrylate” means a (meth)acrylate comprising a polyester chain terminated by a hydroxyl group (i.e. derived from the ring-opening of a cyclic lactone such as caprolactone). Examples of monohydroxylated polyester (meth)acrylates include a di-, tri-, tetra- or polycaprolactone mono(meth)acrylate and mixtures thereof.

The term “ureido group” means a group of formula —NR¹—C(═O)—NR²R³, wherein each R¹, R², R³ is independently selected from H, alkyl, cycloalkyl, or aryl; or R¹ and R² may, with the nitrogen atoms to which they are attached, form a ring; or R² and R³ may, with the nitrogen atom to which they are attached, form a ring. In particular, the ureido group may be a cyclic ureido group such as an imidazolidin-2-one group.

The term “olefin” means an acyclic hydrocarbon that contains at least one carbon-carbon double bond.

The term “mono olefin” means any olefin that contains a single carbon-carbon double bond.

The term “diene” means any olefin that contains two carbon-carbon double bonds. The term “conjugated diene” means a diene where the two carbon-carbon double bonds are separated by a single bond.

The term “vinyl halide” means an acyclic hydrocarbon that contains a single carbon-carbon double bond and a halogen atom (preferably a chlorine atom).

The term “siloxane” means a compound that contains silicon-oxygen-silicon bonds. (Si—O—Si). These bonds can form the backbone of a polymer or may be part of smaller organic molecules.

The term “glass transition temperature” or “T_{g}” refers to the temperature at which a material changes from a glassy state to a rubbery state. In this context, the term “glassy” means that the material is hard and brittle while the term “rubbery” means that the material is elastic and flexible. For polymeric materials, the T_{g} is the critical temperature that separates their glassy and rubbery behaviors. If a polymeric material is at a temperature below its T_{g}, large-scale molecular motion is severely restricted because the material is essentially frozen. On the other hand, if the polymeric material is at a temperature above its T_{g}, molecular motion on the scale of its repeat unit takes place, allowing it to be soft or rubbery.

The glass transition temperature values may be determined in accordance with ASTM E1356-08, “Standard Test Method for Assignment of the Glass Transition Temperatures by Differential Scanning calorimetry” as the inflection temperature (Ti). The glass transition temperatures of the polymers described herein are calculated using the Fox Equation based on the mass fractions and T_{g} values of each individual monomer or oligomer or the polymeric material that includes more than one discrete type of monomer. The T_{g} of the curable composition when cured is determined by the above-described ASTM E1356-08 DSC method or, if not possible owing to a lack of a detectable inflection point, by shear rheology.

The terms “mass fraction” and “weight fraction” are used herein interchangeably and are to be regarded as equivalent to each other with respect to embodiments or examples herein.

The term “photoinitiator” may be considered any type of substance that, upon exposure to radiation (e.g., actinic radiation), forms species that initiate the reaction and curing of polymerizing organic substances present in a composition.

The term ‘block resistance” means the ability of a coating when applied to separate surfaces to stick to itself when pressure is applied push the surfaces together. Block resistance is measured using ASTM D4946-89.

### EMBODIMENTS

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Water-Based Composition

Generally, described in this disclosure are various embodiments of water-based compositions comprising a latex polymer and a photoinitiator component. Such water-based compositions may be suitable for use as coatings such as paints, sealants, sealers, or caulks and may have desirable properties for those applications without the use of hazardous chemicals such as benzophenone, a known carcinogen or MBB, which may have other undesirable environmental impact on rivers and streams.

According to one or more embodiments, the water-based composition may comprise a latex polymer, a photoinitiator component, and optionally a crosslinking component, and optionally a siloxane-based block resistance additive. The water-based composition may not contain benzophenone and/or methyl-o-benzoyl benzophenone. As used herein the term “benzophenone” refers to the organic compound having the formula (C₆H₅)—C(═O)—(C₆H₅), and does not include polymeric benzophenones or other benzophenone derivatives. Thus, a water-based composition that does not contain benzophenone and/or methyl-o-benzoyl-benzoate may still include a polymeric benzophenone or a benzophenone derivative.

### Photoinitiator Component

As described herein, in one or more embodiments the water-based composition comprises a photoinitiator component. The photoinitiator component comprises a photoinitiator. The photoinitiator component may comprise a mixture of two or more photoinitiators.

Upon exposure to radiation, the photoinitiator component may generate radical species that may interact with the organic components of the water-based composition to initiate the polymerization and subsequent curing of the organic components. In embodiments, the photoinitiator component be exposed to with ultraviolet and/or visible light to form radical species. In some embodiments, the photoinitiator component may comprise a Norrish type I photoinitiator and a Norrish type II photoinitiator. A Norrish type photoinitiator undergoes a Norrish reaction which is a photochemical reaction involving aldehydes and/or ketones that forms radical species. A Norrish type I photoinitiator undergoes a cleavage reaction into two radical fragments upon exposure to radiation. A Norrish type II photoinitiator undergoes the abstraction of an atom, such as hydrogen, to generate a radical upon exposure to radiation. Some compounds may comprise both a Norrish type I and a Norrish Type II moiety and act as both a Norrish type I and Norrish Type II photoinitiator. Accordingly, in some embodiments, the photoinitiator component may comprise a photoinitiator comprising both a Norrish type I and a Norrish Type II moiety and optionally a distinct Norrish type I or Norrish type II photoinitiator. Without being bound by theory, it is believed that a photoinitiator component comprising both a Norrish type I and a Norrish type II photoinitiator may have suitable long term gloss retention and dirt pick up resistance without requiring the use of benzophenone and/or methyl-o-benzoyl-benzoate.

In one or more embodiments, the photoinitiator component is present in the water-based composition in an amount from about 0.1 wt. % to about 15 wt. % based on the total weight of polymer solids in the latex polymer, such as from about 0.1 wt. % to about 10 wt. %, from about 0.1 wt. % to about 8 wt. %, from about 0.1 wt. % to about 4 wt. %, from about 0.1 wt. % to about 3 wt. %, from about 0.1 wt. % to about 2 wt. %, from about 0.3 wt. % to about 15 wt. %, from about 0.3 wt. % to about 10 wt. %, from about 0.3 wt. % to about 8 wt. %, from about 0.3 wt. % to about 4 wt. %, from about 0.3 wt. % to about 3 wt. %, from about 0.3 wt. % to about 2 wt. %, from about 0.6 wt. % to about 15 wt. %, from about 0.6 wt. % to about 10 wt. %, from about 0.6 wt. % to about 8 wt. %, from about 0.6 wt. % to about 4 wt. %, from about 0.6 wt. % to about 3 wt. %, from about 0.6 wt. % to about 2 wt. %, from about 0.7 wt. % to about 15 wt. %, from about 0.7 wt. % to about 10 wt. %, from about 0.7 wt. % to about 8 wt. %, from about 0.7 wt. % to about 4 wt. %, from about 0.7 wt. % to about 3 wt. %, from about 0.7 wt. % to about 2 wt. %, from about 0.9 wt. % to about 15 wt. %, from about 0.9 wt. % to about 10 wt. %, from about 0.9 wt. % to about 8 wt. %, from about 0.9 wt. % to about 4 wt. %, from about 0.9 wt. % to about 3 wt. %, from about 0.9 wt. % to about 2 wt. %, or any and all subranges formed from any of these endpoints. For example, the water based composition may comprise from 0.3 wt. % to about 8 wt. %, preferably from about 0.6 wt. % to about 4 wt. %, more preferably from about 0.7 wt. % to about 3 wt. %, and even more preferably from about 0.9 wt. % to about 2 wt. % photoinitiator component based on the weight of polymer solids in the latex polymer.

In one or more embodiments, the photoinitiator component comprises from 10 wt. % to 90 wt. % Norrish type I photoinitiator based on the total weight of the photoinitiator component, such as from 10 wt. % to 80 wt. %, from 10 wt. % to 70 wt. %, from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 90 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 90 wt. %, from 30 wt. % to 80 wt. %, from 30 wt. % to 70 wt. %, from 30 wt. % to 60 wt. %, from 30 wt. % to 50 wt. %, from 30 wt. % to 40 wt. %, from 40 wt. % to 90 wt. %, from 40 wt. % to 80 wt. %, from 40 wt. % to 70 wt. %, from 40 wt. % to 60 wt. %, from 50 wt. % to 50 wt. %, from 40 wt. % to 50 wt. %, from 50 wt. % to 90 wt. %, from 50 wt. % to 80 wt. %, from 50 wt. % to 70 wt. %, from 50 wt. % to 60 wt. %, from 60 wt. % to 90 wt. %, from 60 wt. % to 80 wt. %, from 60 wt. % to 70 wt. %, from 70 wt. % to 90 wt. %, from 70 wt. % to 80 wt. %, from 80 wt. % to 90 wt. %, or any and all subranges formed from any of these endpoints.

In one or more embodiments, the photoinitiator component comprised from 10 wt. % to 90 wt. % Norrish type II photoinitiator based on the total weight of the photoinitiator component, such as from 10 wt. % to 80 wt. %, from 10 wt. % to 70 wt. %, from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 90 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 90 wt. %, from 30 wt. % to 80 wt. %, from 30 wt. % to 70 wt. %, from 30 wt. % to 60 wt. %, from 30 wt. % to 50 wt. %, from 30 wt. % to 40 wt. %, from 40 wt. % to 90 wt. %, from 40 wt. % to 80 wt. %, from 40 wt. % to 70 wt. %, from 40 wt. % to 60 wt. %, from 50 wt. % to 50 wt. %, from 40 wt. % to 50 wt. %, from 50 wt. % to 90 wt. %, from 50 wt. % to 80 wt. %, from 50 wt. % to 70 wt. %, from 50 wt. % to 60 wt. %, from 60 wt. % to 90 wt. %, from 60 wt. % to 80 wt. %, from 60 wt. % to 70 wt. %, from 70 wt. % to 90 wt. %, from 70 wt. % to 80 wt. %, from 80 wt. % to 90 wt. %, or any and all subranges formed from any of these endpoints.

In one or more embodiments, the weight ratio of the Norrish type I photoinitiator to the Norrish type II photoinitiator in the photoinitiator component may be from 1000:1 to 1:1000, such as from 1000:1 to 1:800, from 1000:1 to 1:600, from 1000:1 to 1:400, from 1000:1 to 1:200, from 1000:1 to 1:1, from 1000:1 to 200:1, from 1000:1 to 400:1, from 1000:1 to 600:1, from 1000:1 to 800:1, from 800:1 to 1:1000, from 800:1 to 1:800, from 800:1 to 1:600, from 800:1 to 1:400, from 800:1 to 1:200, from 800:1 to 1:1, from 800:1 to 200:1, from 800:1 to 400:1, from 800:1 to 600:1, from 600:1 to 1:1000, from 600:1 to 1:800, from 600:1 to 1:600, from 600:1 to 1:400, from 600:1 to 1:200, from 600:1 to 1:1, from 600:1 to 200:1, from 600:1 to 400:1, from 400:1 to 1:1000, from 400:1 to 1:800, from 400:1 to 1:600, from 400:1 to 1:400, from 400:1 to 1:200, from 400:1 to 1:1, from 400:1 to 200:1, from 200:1 to 1:1000, from 200:1 to 1:800, from 200:1 to 1:600, from 200:1 to 1:400, from 200:1 to 1:200, from 200:1 to 1:1, from 1:1 to 1:1000, from 1:1 to 1:800, from 1:1 to 1:600, from 1:1 to 1:400, from 1:1 to 1:200, from 1:200 to 1:1000, from 1:200 to 1:800, from 1:200 to 1:600, from 1:200 to 1:400, from 1:400 to 1:1000, from 1:400 to 1:800, from 1:400 to 1:600, from 1:600 to 1:1000, from 1:600 to 1:800, from 1:800 to 1:1000, or any and all subranges formed from any of these endpoints.

Norrish type I photoinitiator moieties may break down upon exposure to radiation into two free radical intermediates. These intermediates can recombine with each other or may interact with other organic molecules that may be present.

Non-limiting examples of Norrish type I photoinitiators include α-hydroxy acetophenones, benzoyl formates, benzoins, benzoin ethers, benzils, benzil ketals, acetophenones, aminoacetophenones, and phoshine oxides.

In embodiments, the Norrish type I photoinitiator may be selected from the group consisting of 2-hydroxy-2-methyl-1-phenylpropanone, 2-hydroxyacetophenone, methyl benzoylformate, 1-hydroxycyclohexyl phenyl ketone, oligo[2-hydroxy-2-methyl-1-[4-(1-methylvinyl)phenyl]propanone]; 2,3-dihydro-6-(2-hydroxy-2-methyl-1-oxopropyl)-1,1,3-trimethyl-3-[4-(2-hydroxy-2-methyl-1-oxopropyl)phenyl]-1H-indene; 2,3-dihydro-5-(2-hydroxy-2-methyl-1-oxopropyl)-1,1,3-trimethyl-3-[4-(2-hydroxy-2-methyl-1-oxopropyl)phenyl]-1H-indene; 1-[4-(2-hydroxyethoxy)-phenyl]-2-hydroxy-2-methylpropan-1-one; ethyl phenyl(2,4,6-trimethylbenzoyl)phosphinate; and mixtures thereof. In an exemplary embodiment, the Norrish type I photoinitiator may be 2-hydroxy-2-methyl-1-phenylpropanone.

Norrish type II (i.e., non-cleavable) photoinitiator moieties do not break down upon exposure to radiation, thus providing fewer possibilities for the leaching of small molecules from the matrix composition. For reference, see e.g. A. Gilbert, J. Baggott: “Essentials of Molecular Photochemistry”, Blackwell, London, 1991). Excited non-cleavable photoinitiators do not break down to radicals upon exposure to radiation, but extract a hydrogen atom from an organic molecule or, more efficiently, extract an electron from an electron donor (such as an amine or a thiol). The electron transfer produces a radical anion on the photoinitiator and a radical cation on the electron donor. This is followed by proton transfer from the radical cation to the radical anion to produce two uncharged radicals; of these the radical on the electron donor is sufficiently reactive to abstract a hydrogen atom from most substrates.

In embodiments, the Norrish Type II photoinitiator may be a substituted diaryl ketone other than benzophenone and methyl-o-benzoyl-benzoate. In embodiments, the Norrish Type II photoinitiator may be selected from the group consisting of 4-methylbenzophenone, 4-benzoyl-4′-methyldiphenyl sulfide, 4-phenylbenzophenone, 2-4-6 trimethylbenzophenone, 2-methylbenzophenone, a polymeric benzophenone (such as Speedcure® 7005 available from Arkema, Omnipol® BP available from IGM, Omnipol® 2702 available from IGM and Ebecryl® P39 available from Allnex), and mixtures thereof. In an exemplary embodiment the Norrish Type II photoinitiator is 4-methylbenzophenone.

In embodiments, the photoinitiator comprising both a Norrish type I and a Norrish Type II moiety may be ethyl [(3-benzoyl-2,4,6-trimethylphenyl) carbonyl](phenyl)phosphinate. Such a photoinitiator may optionally be combined with another Norrish type I photoinitiator such as ethyl phenyl(2,4,6-trimethylbenzoyl)phosphinate.

In some embodiments, the Norrish type I photoinitiator is 2-hydroxy-2-methyl-1-phenylpropanone and the Norrish type II photoinitiator is 4-methylbenzophenone. In some such embodiments, the photoinitiator component may comprise from 40 wt. % to 60 wt. % of 2-hydroxy-2-methyl-1-phenylpropanone and from 40 wt. % to 60 wt. % of 4-methylbenzophenone based on the total weight of the photoinitiator component.

### Latex Polymer

As described hereinabove, the water-based compositions of the present disclosure may comprise a latex polymer. Latex polymers are generally emulsions of polymer particles in an aqueous solution. Latex polymers may be utilized that have a wide range of glass transition temperatures (T_{g}) depending on the intended application. In embodiments, the latex polymer may have a T_{g} of from about −50° C. to about 20° C., such as from about −50° C. to about 10° C., from about −50° C. to about 0° C., from about −50° C. to about −10° C., from about −50° C. to about −20° C., from about −50° C. to about −30° C., from about −50° C. to about −40° C., from about −40° C. to about 20° C., from about −40° C. to about 10° C., from about −40° C. to about 0° C., from about −40° C. to about −10° C., from about −40° C. to about −20° C., from about −40° C. to about −30° C., from about −30° C. to about 20° C., from about −30° C. to about 10° C., from about −30° C. to about 0° C., from about −30° C. to about −10° C., from about −30° C. to about −20° C., from about −20° C. to about 20° C., from about −20° C. to about 10° C., from about −20° C. to about 0° C., from about −20° C. to about −10° C., from about −10° C. to about 20° C., from about −10° C. to about 10° C., from about −10° C. to about 0° C., from about 0° C. to about 20° C., from about 0° C. to about 10° C., from about 10° C. to about 20° C., or any and all subranges formed from any of these endpoints. In some embodiments, the latex polymer may have a T_{g} of from about 5° C. to 20° C. or from about 8° C. to about 14° C.

The latex polymer may be obtained by emulsion polymerization of a monomeric composition comprising one or more ethylenically unsaturated monomers. In other words, the latex polymer may comprise polymerized units derived from one or more ethylenically unsaturated monomers. In particular, the latex polymer may be obtained by single-stage emulsion polymerization of a monomeric composition comprising one or more ethylenically unsaturated monomers or the latex polymer may be obtained by multi-stage emulsion polymerization of a monomeric composition comprising one or more ethylenically unsaturated monomers.

The monomeric composition may comprise monomer (a). Monomer (a) is an alkyl (meth)acrylate. Monomer (a) may be a mixture of alkyl (meth)acrylates.

The alkyl (meth)acrylate is preferably a C1-C12 alkyl (meth)acrylate.

Monomer (a) may comprise or consist of one or more alkyl (meth)acrylates selected from methyl (meth)acrylate, ethyl (meth)acrylate, propyl (meth)acrylate, n-butyl, sec-butyl, isobutyl or tert-butyl (meth)acrylate, 2-ethylhexyl (meth)acrylate, 2-octyl (meth)acrylate, isooctyl (meth)acrylate, nonyl (meth)acrylate, isononyl (meth)acrylate, decyl (meth)acrylate, isodecyl (meth)acrylate, 2-propylheptyl (meth)acrylate, lauryl (meth)acrylate and mixtures thereof.

In a preferred embodiment, monomer (a) comprises or consists of at least one C2-C12 alkyl acrylate, preferably at least one C4-C12 alkyl acrylate, more preferably at least one C4-C12 alkyl acrylate selected from n-butyl acrylate, 2-ethylhexyl acrylate, 2-octyl acrylate, isooctyl acrylate, nonyl acrylate, isononyl acrylate, decyl acrylate, isodecyl acrylate, 2-propylheptyl acrylate and mixtures thereof. In particular, monomer a) may comprise or consist of 2-ethylhexyl acrylate.

In a particularly preferred embodiment, monomer (a) comprises or consists of at least one C4-C12 alkyl acrylate and at least one C1-C4 alkyl methacrylate. In particular, monomer (a) may comprise or consist of a mixture of: at least one C4-C12 alkyl acrylate, more particularly selected from n-butyl acrylate, 2-ethylhexyl acrylate, and mixtures thereof; and at least one C1-C4 alkyl methacrylate, more particularly methyl methacrylate.

The total amount of monomer (a) may be from may be at least 30%, at least 50%, at least 70%, at least 80% or at least 90%, by weight based on the total weight of the ethylenically unsaturated monomers. In particular, the total amount of alkyl (meth)acrylates may be from 30% to 99.5%, from 50% to 99.5%, from 70% to 99%, from 80% to 99% or from 90% to 98%, by weight based on the total weight of the ethylenically unsaturated monomers.

The total amount of C4-C12 alkyl acrylate in monomer (a) may be at least 10%, at least 20%, at least 30%, at least 40% or at least 50%, by weight based on the total weight of monomer (a). In one embodiment, the total amount of C4-C12 alkyl acrylate in monomer (a) may be from 10 to 80%, from 20 to 75%, from 30 to 70%, from 40 to 65% or from 50 to 60%, by weight based on the total weight of the ethylenically unsaturated monomers.

The total amount of 2-ethylhexyl acrylate in monomer (a) may be at least 5%, at least 10%, at least 15%, at least 20%, at least 25% or at least 30%, by weight based on the total weight of monomer (a). In one embodiment, the total amount of 2-ethylhexyl acrylate in monomer (a) may be from 5 to 70%, from 10 to 60%, from 15 to 55%, from 20 to 50%, from 25 to 45%, or from 30 to 40%, by weight based on the total weight of the ethylenically unsaturated monomers.

The monomeric composition may comprise monomer (b). Monomer (b) is a vinyl ester. Monomer (b) may be a mixture of vinyl esters.

Monomer (b) may comprise or consist of one or more vinyl esters selected from vinyl acetate, vinyl propionate, vinyl hexanoate, vinyl 2-ethylhexanoate, vinyl octanoate, vinyl pelargonate, vinyl laurate, vinyl stearate, a vinyl ester of versatic acid and mixtures thereof.

In particular, monomer (b) may comprise or consist of vinyl acetate.

In one embodiment, the monomeric composition is substantially free of monomer (b). In particular, the monomeric composition may comprise less than 1%, less than 0.5%, less than 0.1% or even 0% by weight, of monomer (b) based on the total weight of the ethylenically unsaturated monomers. For example, the monomeric composition may comprise from 0 to less than 1%, from 0 to 0.5%, from 0 to 0.1%, or even 0% by weight of monomer (b) based on the total weight of the ethylenically unsaturated monomers.

In another embodiment, the monomeric composition comprises monomer (b) and the total amount of monomer (b) may be at least 1%, at least 5%, at least 10%, at least 15%, or at least 20%, by weight of monomer (b) based on the total weight of the ethylenically unsaturated monomers. For example, the monomeric composition may comprise from 1 to 95%, from 1 to 85%, from 1 to 80%, from 1 to 75%, from 1 to 70%, from 1 to 65%, from 1 to 60%, from 1 to 50%, from 10% to 95% % or from 20% to 90% %, or from 35 to 75%, by weight of monomer (b) based on the total weight of the ethylenically unsaturated monomers. Alternatively, the monomeric composition may comprise from 1 to 30%, from 2% to 20% or from 5% to 10%, by weight of monomer (b) based on the total weight of the ethylenically unsaturated monomers.

The monomeric composition may comprise monomer (c). Monomer (c) is a vinyl aromatic. Monomer (c) may be a mixture of vinyl aromatic.

Monomer (c) may comprise or consist of one or more vinyl aromatics selected from styrene, alpha-methylstyrene, tert-butylstyrene, ortho-, meta-, and para-methylstyrene, ortho-, meta- and para-ethylstyrene, o-methyl-p-isopropylstyrene, p-chlorostyrene, p-bromostyrene, o,p-dichlorostyrene, o,p-dibromostyrene, ortho-, meta- and para-methoxystyrene, optionally substituted indenes, optionally substituted vinylnaphthalenes, acenaphthylene, diphenylethylene, vinyl anthracene and mixtures thereof. In particular, monomer (c) may comprise or consist of one or more vinyl aromatics selected from styrene, alpha-methylstyrene and mixtures thereof.

In one embodiment, the monomeric composition is substantially free of monomer (c). In particular, the monomeric composition may comprise less than 1%, less than 0.5%, less than 0.1% or even 0% by weight, of monomer (c) based on the total weight of the ethylenically unsaturated monomers. For example, the monomeric composition may comprise from 0 to less than 1%, from 0 to 0.5%, from 0 to 0.1%, or even 0% by weight of monomer (c) based on the total weight of the ethylenically unsaturated monomers.

In another embodiment, the monomeric composition comprises monomer (c) and the total amount of monomer (c) may be at least 1%, at least 5%, at least 10%, at least 15%, or at least 20%, by weight of monomer (c) based on the total weight of the ethylenically unsaturated monomers. For example, the monomeric composition may comprise from 1% to 60%, from 5% to 55%, from 10% to 45% or from 20% to 40%, by weight of monomer (c) based on the total weight of the ethylenically unsaturated monomers. Alternatively, the monomeric composition may comprise from 1% to 30%, from 2% to 20% or from 5% to 10%, by weight of monomer (c) based on the total weight of the ethylenically unsaturated monomers.

The monomeric composition may comprise monomer (d). Monomer (d) is an acidic monomer. Monomer (d) may be a mixture of acidic monomers.

Monomer (d) may comprise or consist of one or more acidic monomers selected from C3-C10 mono- or dicarboxylic acids, cyclic anhydrides, phosphorous-based acidic monomers, sulfur-based acidic monomers, salts thereof and mixtures thereof.

In a first embodiment, monomer (d) may comprise or consist of an acidic monomer (d1) selected from mono- or dicarboxylic acid monomers, cyclic anhydride monomers and salts thereof. Monocarboxylic acid monomers can be selected from (meth)acrylic acid, 2-chloroacrylic acid, p-styrene carboxylic acid, 3-butenoic acid, 2-carboxyethyl acrylate, ethyl acrylic acid, crotonic acid, vinyl acetic acid and their combinations. As dicarboxylic acid monomers and cyclic anhydride monomers, mention can be made of: fumaric acid, maleic acid, maleic anhydride, tetrahydrophthalic acid, tetrahydrophthalic anhydride, itaconic acid, mesaconic acid, citraconic acid, glutaconic acid, muconic acid and their combinations.

Preferably, monomer (d1) comprises or consists of (meth)acrylic acid, more preferably methacrylic acid.

In a second embodiment, monomer (d) may comprise or consist of an acidic monomer (d2) selected from the group consisting of phosphorous-based (P-based) acidic monomers, sulfur-based (S-based) acidic monomers and mixtures thereof.

Suitable examples of P-based acidic monomers (d2) may be as described in EP 1715001. Suitable examples of P-based acidic monomers (d2) include vinyl phosphonic acid, phosphoric acid monovinyl ester, allylphosphonic acid, phosphoric acid monoallyl ester, 3-butenylphosphonic acid, phosphoric acid mono-3-butenyl ester, phosphoric acid mono-4-vinyloxybutyl ester, phosphoric acid mono-2-hydroxy-3-vinyloxypropyl ester, phosphoric acid mono-1-phosphonoxymethyl-2-vinyloxyethyl ester, phosphoric acid mono-3-allyloxy-2-hydroxypropyl ester, phosphoric acid mono-2-allyloxy-1-phosphonoxymethylethyl ester, 2-hydroxy-4-vinyloxymethyl-1,3,2-dioxaphosphole, 2-hydroxy-4-allyloxymethyl-1,3,2-dioxaphosphole, phosphoric acid 3-[2-(allyloxy)-2-oxoethyl]phenyl ester, and a compound of formula

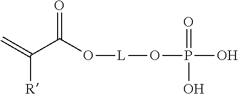

wherein R′ is H or methyl and L is an optionally alkoxylated (i.e. ethoxylated, propoxylated, and/or butoxylated) alkylene linker, in particular L is a C1-10 alkylene linker which is optionally interrupted by one or more oxyalkylene (i.e. oxyethylene, oxypropylene and/or oxybutylene) units; as well as salts thereof (in particular lithium, sodium, potassium or ammonium salts thereof) and mixtures thereof.

Suitable examples of S-based acidic monomers (d2) include from vinyl sulfonic acid, sulfuric acid monovinyl ester, allylsulfonic acid, sulfuric acid monoallyl ester, 2-acrylamido-2-methyl-1-propane sulfonic acid, styrene sulfonic acid, acryloyloxybenzenesulfonic acid, (meth)acryloyloxynaphthalenesulfonic acid, 2-propene-1-sulfonic acid, 2-methyl-2-propene-1-sulfonic acid, 1-allyloxy-2-hydroxypropane sulfonic acid, 3-allyloxy-2-hydroxypropane sulfonic acid, and a compound of formula

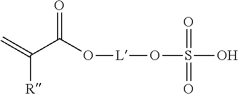

wherein R″ is H or methyl and L′ is an optionally alkoxylated (i.e. ethoxylated, propoxylated, and/or butoxylated) alkylene linker, in particular L′ is a C1-10 alkylene linker which is optionally interrupted by one or more oxyalkylene (i.e. oxyethylene, oxypropylene and/or oxybutylene) units; as well as salts thereof (in particular lithium, sodium, potassium or ammonium salts thereof) and mixtures thereof.

Preferably, monomer (d2) comprises or consists of a 2-acrylamido-2-methyl propane sulfonic acid salt and more preferably a sodium salt thereof.

In a third embodiment, monomer (d) comprises or consists of a mixture of (d1) and (d2) as defined above.

Preferably, monomer (d) comprises or consists of (meth)acrylic acid, more preferably methacrylic acid.

The total amount of monomer (d) may be from 0 to 5%, from 0.5 to 5%, from 0.8 to 4%, from 1 to 3%, or from 1 to 2%, by weight based on the total weight of the ethylenically unsaturated monomers.

The monomeric composition may comprise monomer (e). Monomer (e) is a functionalized monomer. Monomer (e) may be a mixture of functionalized monomers.

The functionalized monomer may comprise 2 to 30 carbon atoms and an ethylenically unsaturated group selected from the group consisting of acryloyl (—C(═O)—CH═CH₂), methacryloyl (—C(═O)—C(CH₃)—CH₂), vinyl (CH═CH₂), crotyl (—CH—CH(CH₃)) or allyl (—CH₂—CH═CH₂). The functional group may be selected from the group consisting of hydroxyl, ketone, aldehyde, acetoacetoxy, acetoacetamide, 1,1-dimethyl-3-oxobuyl (diacetone), glycidyl ether, amino (—NH₂), alkylamino or dialkylamino (—NHR or —NR² with R is alkyl), cyano (—CN) or a heterocycle with one or more nitrogen ring atoms (in particular a ureido group).

In particular, monomer (e) may comprise or consist of one or more functionalized monomers selected from the group consisting of a hydroxylated (meth)acrylate (such as a hydroxyalkyl (meth)acrylate, a monohydroxylated polyether (meth)acrylate or monohydroxylated polyester (meth)acrylate), glycidyl (meth)acrylate, acetoacetoxyethyl (meth)acrylate, acetoacetoxypropyl (meth)acrylate, acetoacetobutyl (meth)acrylate, 2,3-di(acetoacetoxy)propyl (meth)acrylate, diacetone (meth)acrylate, acetonyl (meth)acrylate, allyl acetoacetate, vinyl acetoacetate, methylvinylketone, ethylvinylketone, butylvinylketone, (meth)acroleine, crotonaldehyde, formylstyrene, N-vinyl pyrrolidine, N-vinyl caprolactam, (meth)acrylonitrile, α-chloroacrylonitrile, α-bromoacrylonitrile, (meth)acrylamide, N-methyl (meth)acrylamide, N-ethyl (meth)acrylamide, N-isopropyl (meth)acrylamide, N-cyclohexyl (meth)acrylamide, N-cyclopentyl (meth)acrylamide, N-methoxymethyl (meth)acrylamide, N-butoxymethyl (meth)acrylamide, N,N-dibutyl (meth)acrylamide, N-butyl (meth)acrylamide, N,N-diethyl (meth)acrylamide, N,N-dimethyl (meth)acrylamide, N-octyl (meth)acrylamide, N-decyl (meth)acrylamide, N-dodecyl (meth)acrylamide, N-octadecyl (meth)acrylamide, N-isopropyl (meth)acrylamide, N-tert-butyl (meth)acrylamide, N-isobutyl (meth)acrylamide, N,N,3,3-tetramethylacrylamide, N-phenyl (meth)acrylamide, N-(meth)acryloyl morpholine, diacetone acrylamide, N-methylol (meth)acrylamide, 2-aminoethyl (meth)acrylate, t-butyl aminoethyl methacrylate, dimethylaminoethyl methacrylate, diethylaminoethyl methacrylate, N—(N,N-dimethylamino)ethyl (meth)acrylamide; N,—(N,N-dimethylamino) propyl (meth)acrylamide, 2-t-butylaminoethyl methacrylate, N,N-dimethylaminoethylacrylate, 2-(2-oxo-1-imidazolidinyl)ethyl (meth)acrylate and 2-(2-oxo-1-imidazolidinyl)ethyl (meth)acrylamide, and mixtures thereof.

In a preferred embodiment, monomer (e) may comprise or consist of one or more ethylenically unsaturated compounds bearing a hydroxyl functional group, in particular a hydroxylated (meth)acrylate, and/or one or more ethylenically unsaturated compounds bearing a ureido functional group, in particular 2-(2-oxo-1-imidazolidinyl)ethyl (meth)acrylate.

In one embodiment, monomer (e) does not contain any (meth)acrylamide.

The total amount of monomer (e) may be from 0 to 5%, from 0.5% to 5%, from 0.8% to 4%, from 1% to 3%, or from 1.5% to 2.5%, by weight based on the total weight of the ethylenically unsaturated monomers.

The ethylenically unsaturated monomers may comprise monomer (f). Monomer (f) comprises or consists of one or more ethylenically unsaturated monomers bearing a silane group.

The ethylenically unsaturated monomer bearing a silane group may comprise 2 to 30 carbon atoms and a group selected from methacryloyl (—C(═O)C(CH₃) CH₂) and vinyl (—CH═CH₂). The silane group may be an alkoxysilane group, in particular an alkoxysilane group having the following formula:

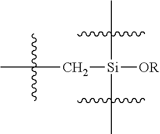

where R is an alkyl, in particular R is an alkyl comprising 1-6 carbon atoms, more particularly R is methyl or ethyl.

In one embodiment, the silane group is a dialkoxysilane or a trialkoxysilane group, in particular a dialkoxysilane group having the following formula:

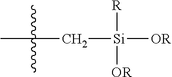

or a trialkoxylsilane group having the following formula:

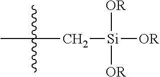

wherein each R is independently an alkyl, in particular an alkyl comprising 1-6 carbon atoms, more particularly methyl or ethyl.

In particular, monomer (f) may comprise or consist of one or more monomers selected from 3-methacryloxypropyl tri(alkoxy)silane, methacryloxymethyl tri(alkoxy)silane, 3-methacryloxypropylmethyl di(alkoxy)silane, vinylalkyl di(alkoxy)silane, vinyl tri(alkoxy)silane and mixtures thereof.

More particularly, monomer (f) may comprise or consist of one or more monomers from vinyl trimethoxysilane, vinyl diimethoxymethylsilane, vinyl triethoxysilane, vinyl tripropoxysilane, vinyl triisopropoxysilane, vinyl tris(methoxyethoxy)silane, vinyl tributoxysilane, vinyl triacetoxysilane, 3-methacryloxypropyl trimethoxysilane, 3-methacryloxypropylmethyl dimethoxysilane, methacryloxymethyl trimethoxysilane, 3-methacryloxypropyl tris(2-methoxyethoxy)silane, vinyl trichlorosilane, vinyl methyldichlorosilane, vinyltris(2-methoxyethoxy)silane and mixtures thereof.

Even more particularly, monomer (f) may comprise or consist of 3-methacryloxypropyl trimethoxysilane.

The total amount of monomer (f) may be from 0 to 5%, from 0 to 2%, from 0 to 1%, or from 0 to 0.5%, by weight based on the total weight of the ethylenically unsaturated monomers.

The ethylenically unsaturated monomers may comprise monomer (g). Monomer (g) comprises or consists of one or more crosslinking monomers.

A crosslinking monomer may be a compound bearing at least two functional groups which are capable of reacting with ethylenically unsaturated monomers. In particular, a crosslinking monomer may comprise at least two polymerizable carbon-carbon double bonds.

Monomer (g) may comprise or consist of one or more crosslinking monomers selected from a multifunctional (meth)acrylate, a polyvinylic monomer, a compound comprising both a (meth)acrylic group and a vinyl group and mixtures thereof.

More particularly, monomer (g) may comprise or consist of one or more crosslinking monomers selected from allyl (meth)acrylate, diallyl (meth)acrylate, vinyl acrylate, divinyl benzene, diallyl ether, glycerol diallyl ether, glycerol triallyl ether, trimethylolpropane diallyl ether, trimethylolpropane triallyl ether, pentaerythritol triallyl ether, diallyl phthalate, dicyclopentenyl oxyethyl methacrylate, ethylene glycol di(meth)acrylate, di-, tri- or tetraethylene glycol di(meth)acrylate, propylene glycol di(meth)acrylate, di-, tri- or tetrapropylene glycol di(meth)acrylate, 1,2-butanediol di(meth)acrylate, 2,3-butanediol di(meth)acrylate, 1,3-butanediol di(meth)acrylate, 1,4-butanediol di(meth)acrylate, 1,5-pentanediol di(meth)acrylate, 1,6-hexanediol di(meth)acrylate, neopentyl glycol di(meth)acrylate, 2-methyl-2,4-pentanediol di(meth)acrylate, polybutadiene di(meth)acrylate, cyclohexane-1,4-dimethanol di(meth)acrylate, tricyclodecane dimethanol di(meth)acrylate, trimethylolethane tri(meth)acrylate, trimethylolethane di(meth)acrylate, trimethylolpropane tri(meth)acrylate, trimethylolpropane di(meth)acrylate, pentaerythritol di(meth)acrylate, pentaerythritol tri(meth)acrylate, pentaerythritol tetra(meth)acrylate, di(trimethylolpropane) diacrylate, di(trimethylolpropane) triacrylate, di(trimethylolpropane) tetra(meth)acrylate, sorbitol penta(meth)acrylate; di(pentaerythritol) tetra(meth)acrylate; di(pentaerythritol) penta(meth)acrylate; di(pentaerythritol) hexa(meth)acrylate; tris(2-hydroxyethyl) isocyanurate tri(meth)acrylate, as well as the alkoxylated (e.g., ethoxylated and/or propoxylated) derivatives thereof; and mixtures thereof.

The total amount of monomer (g) may be from 0 to 5%, from 0 to 2%, from 0 to 1%, or from 0 to 0.5%, by weight based on the total weight of the ethylenically unsaturated monomers.

Monomers (a), (b), (c), (d), (e), (f), and (g) are distinct from one another. The type and amount of monomers (a), (b), (c), (d), (e), (f), and (g) may be adjusted so that the resulting polymer particles exhibit the desired T_{g} as defined above.

In one or more embodiments, the monomeric composition may comprise or consist of one or more ethylenically unsaturated monomers selected from the group consisting of alkyl (meth)acrylates, vinyl aromatics, vinyl esters, acidic monomers, functional monomers, monoolefins, conjugated dienes, vinyl halides and combinations thereof. In particular, the one or more ethylenically unsaturated monomers may be selected from the group consisting of 2-ethylhexyl acrylate, methyl methacrylate, butyl acrylate, methacrylic acid, hydroxyethyl acrylate, styrene, alpha-methyl acrylic acid, styrene, acrylonitrile, vinyl chloride, 2-(2-oxo-1-imidazolidinyl)ethyl (meth)acrylate and combinations thereof.

The monomeric composition may comprise or consist of one or more ethylenically unsaturated monomers selected from the group consisting of alkyl (meth)acrylates, acidic monomers and combinations thereof. In particular, the one or more ethylenically unsaturated monomers may be selected from the group consisting of 2-ethylhexyl acrylate, methyl methacrylate, butyl acrylate, methacrylic acid, and combinations thereof.

In one or more embodiments, the latex polymer may comprise from 0 wt. % to about 90 wt. %, from 5 wt. % to about 80 wt. %, from about 10 wt. % to about 70 wt. %, from about 15 wt. % to about 60 wt. %, from about 20 wt. % to about 55 wt. %, preferably from about 5 wt. % to 30 wt. %, more preferably from about 10 wt. % to about 25 wt. % of 2-ethylhexyl acrylate. In one or more embodiments, the latex polymer may comprise from about 0 wt. % to about 60 wt. %, from about 10 wt. % to about 50 wt. %, from about 20 wt. % to about 40 wt. %, preferably from about 20 wt. % to 50 wt. %, more preferably from about 40 wt. % to about 50 wt. % of methyl methacrylate. In one or more embodiments, the latex polymer may comprise from about 10 wt. % to about 90 wt. %, or from about 20 wt. % to about 80 wt. %, or from 30 wt. % to about 70 wt. %, from about 40 wt. % to about 60 wt. %, preferably from about 30 wt. % to about 60 wt. %, more preferably from about 40 wt. % to about 50 wt. % of butyl acrylate. In one or more embodiments, latex polymer may comprise from about 0 wt. %, or from 0.5 wt. % to about 5 wt. % of methacrylic acid, preferably from about 1 wt. % to about 3 wt. %, or from about 1 wt. % to about 2 wt. %, based on total monomer composition (100% monomer composition, excluding water, surfactants).

As described hereinabove, in one or more embodiments, the latex polymer may comprise from 0 wt. % to 90 wt. % of 2-ethylhexyl acrylate, such as from 0 wt. % to about 80 wt. %, from about 0 wt. % to about 70 wt. %, from about 0 wt. % to about 60 wt. %, from about 0 wt. % to about 50 wt. %, from about 0 wt. % to about 40 wt. %, from about 0 wt. % to about 30 wt. %, from about 0 wt. % to about 20 wt. %, from about 0 wt. % to about 10 wt. %, from about 0 wt. % to about 5 wt. %, from about 5 wt. % to about 40 wt. %, from about 5 wt. % to about 35 wt. %, from about 5 wt. % to about 30 wt. %, from about 5 wt. % to about 25 wt. %, from about 5 wt. % to about 20 wt. %, from about 5 wt. % to about 15 wt. %, from about 5 wt. % to about 10 wt. %, from about 10 wt. % to about 40 wt. %, from about 10 wt. % to about 35 wt. %, from about 10 wt. % to about 30 wt. %, from about 10 wt. % to about 25 wt. %, from about 10 wt. % to about 20 wt. %, from about 10 wt. % to about 15 wt. %, from about 15 wt. % to about 35 wt. %, from about 15 wt. % to about 30 wt. %, from about 15 wt. % to about 25 wt. %, from about 15 wt. % to about 20 wt. %, from about 20 wt. % to about 35 wt. %, from about 20 wt. % to about 30 wt. %, from about 20 wt. % to about 25 wt. %, from about 25 wt. % to about 35 wt. %, from about 25 wt. % to about 30 wt. %, from about 30 wt. % to about 35 wt. %, or any and all subranges from any of these endpoints.

In a preferred embodiment the latex polymer may comprise, based on the total weight of monomers in the latex polymer from about 10 wt. % to about 30 wt. % of 2-ethylhexyl acrylate, from about 40 wt. % to about 50 wt. % of methyl methacrylate; from about 40 wt. % to about 50 wt. % of butyl acrylate; from about 1 wt. % to about 2 wt. % of methacrylic acid and optionally about 1 wt. % to about 2 wt. % of 2-(2-oxo-1-imidazolidinyl)ethyl (meth)acrylate.

The monomeric composition used to obtain the latex polymer may further comprise at least one surfactant. The monomeric composition may comprise a mixture of surfactants. The surfactant may be a compound having both a hydrophilic and a hydrophobic part that is able to form micelles of monomer. The surfactant may act as a stabilizer during and/or after the emulsion polymerization.

The surfactant may be selected from an anionic surfactant, a non-ionic surfactant and mixtures thereof, preferably a mixture of anionic surfactants. Examples of preferred surfactants include, but are not limited to an alkyl sulfate, an alkyl ether sulfate, an alkyl sulfonate, an alkyl benzenesulfonate, an optionally substituted diphenyl oxide disulfonate, an optionally ethoxylated sulfosuccinate mono- or diester, a phosphonate mono- or diester, a phosphate mono- or diester, an ethoxylated fatty alcohol, an optionally ethoxylated fatty acid, an ethoxy-propoxy copolymer (EO-PO copolymer), salts thereof, and mixtures thereof. A list of suitable surfactants is available in the book “Surfactants and Polymers in Aqueous solutions” (Holmberg et al., 2002, John Wiley & Sons).

Examples of suitable sulfosuccinate mono- or diesters are optionally ethoxylated C6-C20 alkyl monoesters or diesters of sulfosuccinic acid (like Aerosol® A-102, Aerosol® MA-80, Aerosol® GPG).

Examples of suitable phosphate mono- or diesters are optionally alkoxylated alkyl phosphate monoester-diacids or salts, optionally alkoxylated alkyl diphosphate diester-monoacids or salts or mixtures thereof (like Rhodafac® Rs 410, Rhodafac® Rs 610 Rhodafac® Rs 710, Rhodafac® Rs 960).

In one embodiment, the surfactant is a mixture of an optionally ethoxylated sulfosuccinate mono- or diester and an alkyl ether sulfate. Ethoxylated alcohols, alkyldiaryloxide disulfonates, alkyl aryl polyglycol ethers, and alkylphenol ethoxylates are also options.

The total amount of surfactant in the monomeric composition may be from 0.01% to 5%, in particular from 0.1% to 2%, more particularly from 0.2% to 1.5%, by weight of surfactant based on the total weight of the ethylenically unsaturated monomers.

The monomeric composition used to obtain the latex polymer may further comprise at least one initiator. The monomeric composition may comprise a mixture of initiators.

The initiator may comprise a water-soluble free radical initiator. Such initiators are well known in the art and include, for example, peroxides especially inorganic persulfate compounds such as ammonium persulfate, potassium persulfate and sodium persulfate; hydrogen peroxide; organic hydroperoxides such as cumene hydroperoxide, t-butyl hydroperoxide, acetyl peroxide, benzoyl peroxide or lauroyl peroxide; peracids such as peracetic acid and perbenzoic acid; redox systems comprising a peroxide and a reducing agent (in particular ferrous compounds; carboxylic acids; alkali metal salts of sulfurous acid such as sodium sulfite or sodium hydrogensulfite; alkali metal salts of disulfurous acid such as sodium metabisulfite; bisulfite addition compounds of aliphatic aldehydes and ketones such as acetone bisulfite; hydroxymethanesulfinic acid and its salts; sulfinic acid derivatives like Bruggolite FF6 and FF7; thiosulfate salts such a sodium thiosulfate; and combinations thereof), which promote the decomposition of the peroxide; as well as other free radical producing materials such as an azo-initiator, for example 2,2′-azobisisobutyronitrile, 4,4′-azobis(4-cyanovaleric acid) or 2,2′-azobis(2-methylbutyronitrile); and combinations thereof.

The total amount of initiator in the monomeric composition may be from 0.01% to 3.0%, in particular from 0.1% to 2.0%, more particularly from 0.2% to 1.5%, by weight of initiator based on the total weight of the ethylenically unsaturated monomers.

### Other Components

In certain embodiments, the water-based composition may optionally include a crosslinking component. The crosslinking component may be a compound that is able to react with a functional group which is present on the latex polymer (due to the use of an ethylenically unsaturated monomer bearing said functional group to prepare the latex polymer). Examples of such functional groups include carboxylic acid, hydroxyl, epoxy, carbonyl, amino, ureido, cyano or silane. The crosslinking component may be selected from the group consisting of a polyisocyanate, melamine, a dihydrazide (such as adipic acid dihydrazide (ADH)), hydrazine, a dihydrazone, a polyamine, a silane-based crosslinker, and mixtures or combinations thereof.

In embodiments where the water-based composition does include a crosslinking component, the water-based composition may comprise from about 0 to about 5 wt %, from about 1 wt. % to about 4 wt. % of a crosslinking component based on the weight of the polymer solids (i.e., monomers) in the water-based composition, or from about 1 wt. % to about 3.5 wt. %.

In certain embodiments, the water-based composition may optionally include a siloxane-based block additive such as, for example, polyethersiloxane copolymers and silicone-polyether block copolymers, trisiloxanes, and reactive silicone additives.

In one or more embodiments, the water-based composition may further comprise at least one of the following: pigment(s), thickener(s), defoamer(s), mildewcide(s), biocide(s), dispersant(s), surfactant(s), filler(s), and combinations thereof. In one or more embodiments, the water-compositions may be a paint, sealant, sealer or caulk. The additives that may be added to the water-based composition may depend on the intended use of the composition. For example, if the water-based composition is a paint or a sealant then it will likely include one or more pigments and if it is to be used a sealer it may include a defoamer and/or a surfactant.

### Process for the Preparation of the Water-Based Composition

The water-based compositions of the present disclosure may be prepared by mixing a photoinitiator component and the latex polymer together. The photoinitiator component may be prepared by dissolving the Norrish type II photoinitiator as a solid in the Norrish type I photoinitiator as a liquid to obtain the photoinitiator component. In some embodiments, the photoinitiator component may be a homogenous liquid mixture. In some embodiments, the photoinitiator component may be a eutectic mixture. A eutectic mixture is a homogenous mixtures of substances that has a melting point lower than the melting point of any of the constituents of the mixture. Without being bound by theory it is believed that by dissolving the Norrish type II photoinitiator in the Norrish type I photoinitiator to obtain the photoinitiator component, the photoinitiator component can be added to the water-based composition without the addition of coalescent compounds.

The latex polymer may be prepared using any known emulsion polymerization procedure which produces polymer dispersions in aqueous latex form. Such procedures are described in, for example, Encyclopedia of Polymer Science and Engineering, Vol. 8, p. 659 ff (1987).

Emulsion polymerization may be conducted from a system comprising water, ethylenically unsaturated monomers, optionally one or more surfactants and optionally one or more initiators. The emulsion polymerization process typically starts by dispersing the monomers (organic phase) in water (aqueous phase) optionally in the presence of one or more surfactants to provide an emulsion. One or more initiators are optionally dissolved in the aqueous phase to provide a source of free radicals that may initiate polymerization. The dispersed monomer droplets act as reservoirs supplying monomer to the growing polymer particles by diffusion through the water. The polymer particles may be prevented from coalescing with each other by the surfactant. The emulsion polymerization therefore provides as a product an aqueous dispersion of polymer particles, i.e a latex polymer.

The emulsion polymerization may be conducted with the monomeric composition described above. The emulsion polymerization may be conducted using the following conditions. A pre-emulsion comprising ethylenically unsaturated monomers and optionally one or more surfactants in water may be prepared. A solution of at least one initiator in water may be separately prepared. The pre-emulsion and the initiator solution may be fed in a reactor.

The introduction of the pre-emulsion may be continuous, for example over a time of 2 to 10 hours, in particular 4 to 8 hours. Alternatively, the introduction of the pre-emulsion may be discontinuous, for example part of the pre-emulsion may first be introduced in the reactor to form seed particles and the remainder of the pre-emulsion may be introduced in one or more successive steps. The ethylenically unsaturated monomers in the seed part of the pre-emulsion may represent from 0.05% to 10% by weight of the total weight of ethylenically unsaturated monomers. The emulsion polymerization may be a multi-stage emulsion polymerization with at least two successive steps of polymerization using different monomeric compositions.

The introduction of the initiator solution depends on the chemical nature of the initiator system and the kind of polymerization process. The initiator solution can be introduced in the reactor continuously or stepwise in the course of the emulsion polymerization. Normally, it is preferred to introduce part of the initiator solution in the reaction in a first step and then feeding the remainder into the reactor according to the monomers feed.

The temperature of the reactor during the emulsion polymerization may be maintained in the range 30° C. to 120° C., preferably from 60° C. to 100° C.

The preparation process of the latex polymer may comprise a post-polymerization treatment step. The post-polymerization treatment is conducted after the emulsion polymerization. The post-polymerization treatment may be conducted directly after the emulsion polymerization. The post-polymerization treatment may be conducted without cooling the emulsion polymerization medium.

The post-polymerization treatment may comprise adding a chase to the aqueous polymer dispersion. The chase may comprise an oxidizing agent and optionally a reducing agent. The oxidizing agent and the reducing agent may be as described above for the initiator. In particular, the chase may comprise tert-butyl hydroperoxide and sodium metabisulfite.

### EXAMPLES

### Preparation of the Latex

Latex synthesis was conducted at about 80° C. in a 3-liter, jacketed glass reactor equipped with an agitator and thermocouple. An initial charge consisting of 365 g of water, 10 g of ENCOR 9710 (seed latex available from Arkema) 0.2 g of Rhodoline 635 (a silicone-free oil-based defoamer, available from Solvay), and 50 g of rinse water was loaded into the reactor and heated to about 80° C. An initial oxidizer solution (ammonium persulfate in water) was added to the reactor. Then, the pre-emulsified monomer mix (water, 450 g butyl acrylate, 440 g methyl methacrylate, 150 g of 2-ethylhexyl acrylate (2-EHA), 15 g of methacrylic acid, about 50 g of Certipol FES993 (an emulsifier based on a fatty alcohol polyglycol ether sulfate, sodium salt, available from Kensing) about 20 g of wet adhesion monomer (e.g. (2-(2-oxo-1-imidazolidinyl)ethyl (meth)acrylate), and 17 g of Aerosol A-102 (an anionic surfactant available from Solvay) and third stream feed (ammonium hydroxide in water (r) were fed over 230 minutes. A delayed oxidizer (ammonium persulfate in water) was fed over time. A defoamer was added.

After the monomer feed was complete, the reaction was held for 40 minutes at about 80° C. A post oxidizer (0.8 g of t-butyl hydroperoxide in water) and a post reducer (1 g of sodium metabisulfite in water) were fed over time. Then, the reaction was cooled to 60° C. and held for 15 minutes.

Ammonium hydroxide, defoamer, water, and a biocide package were post added to the latex. Equal parts of the active ingredient (Norrish Type II photo-initiator) was post added to the latex.

The coating composition was prepared in an internal semigloss grind base. A 7-mil drawdown of each semigloss paint was applied to treated aluminum panels. Coated panels were allowed to dry in an environmental chamber with controlled temperature and humidity for at least 24 hours. Using a colorimeter, initial readings for reflectance (% Y) and yellowness index (YE) were taken for each paint film.

Additionally, using a glossmeter, 20°, 60°, and 85° gloss measurements were taken for each paint film. Once all initial observations and readings were collected and recorded, samples were loaded into a QUV weathering cabinet. Coated panels in the QUV weathering cabinet were exposed using a constant UV cycle at 60° C.±5° C. Reflectance, yellowness index, and gloss measurements were measured for each film every 250 hours, for a total of 2000 hours.

### Example 1

In Example 1, with respect to the photo-initiator, four examples were tested. Table 1 lists the photo-initiator including its Norrish Type characterization.

TABLE 1
Photo-initiator, and Norrish Type characterization.

| | | Norrish |
|---|---|---|
| Photo-Initiator | Description | Type |
| SC7005 (comparative) | polymeric benzophenone | II |
| PI-006 (comparative) | 20% 4-methylbenzophenone in SC7005 | II in II |
| Optifilm blend | 50% 4-methylbenzophenone in Optifilm 400* | II in N/A |
| (comparative) | | |
| SC510 (inventive) | 50% 4-methylbenzophenone in 2-hydroxy-2-methyl- | II in I |
| | 1-phenylpropanone | |

*a coalescent, available from Eastman Chemical

Gloss retention after 1000 hours of QUV exposure and dirt pick up resistance performance (DPUR) are shown in Table 2 for five samples. The desired result for gloss retention is to be retained at or close to 100%. The desired result for dirt pick up resistance is for no change or close to 0%.

TABLE 2
Gloss retention after 1000 hours of QUV exposure and dirt
pick up resistance [reported as % Y (color) change]
for samples of Example 1 differing in photo-initiator packages

| | Active | 2-EHA | Active | Gloss | % Y |
|---|---|---|---|---|---|
| Sample | Component | (wt. %) | (pts) | Retention | Change |
| A | SC7005 | 0 | 0.75 | about 55% | about 5% |
| (comparative) | | | | | |
| B | PI-006 | 0 | 0.75 | about 60% | about 10% |
| (comparative) | | | | | |
| C | Optifilm | 0 | 0.75 | about 50% | about 5% |
| (comparative) | blend | | | | |
| D | SC510 | 0 | 0.75 | about 40% | about 25% |
| (inventive) | | | | | |
| E | SC510 | 12.5 | 0.63 | about 80% | about 5% |
| (inventive) | | | | | |

As depicted in Table 2, Samples A-D retain 40-60% of the gloss retention. The best performing sample for both gloss retention and dirt pick up performance is Sample E (of the invention). Samples D and E each contain SC510 photo-initiator. Sample E differs from Sample D by the inclusion of the 2-ethylhexylacrylate monomer. A combination of 2-ethylhexylacrylate monomer with the SC510 photo-initiator package provided the highest gloss retention and lowest dirt pick up.

### Example 2

In Example 2, Four levels of 2-ethylhexyl acrylate were tested (0%, 12.5%, 25%, and 50% replacement of butyl acrylate with 2-ethylhexyl acrylate) to demonstrate the unexpected synergistic effect between 2-ethylhexyl acrylate and SC510. As depicted in Table 3, a synergistic effect is seen with increasing levels of 2-ethylhexyl acrylate and SC510: higher gloss retention and lower dirt pick up. Additionally, the greatest effect/synergy is seen at 12.5% 2-ethylhexyl acrylate and SC510 (Sample M).

TABLE 3
Gloss retention after 1000 hours of QUV exposure and dirt pick
up resistance [reported as % Y (color) change] for samples
of Example 2, varying in 2-ethylhexyl acrylate with photo-initiator.

| | Active | 2-EHA | Active | Gloss | |
|---|---|---|---|---|---|
| Sample | Component | (wt. %) | (pts) | Retention | % Y Change |
| L | SC510 | 0 | 0.75 | about 40% | about 25% |
| (inventive) | | | | | |
| M | SC510 | 12.5 | 0.63 | about 80% | about 5% |
| (inventive) | | | | | |
| N | SC510 | 25 | 0.75 | about 55% | about 10% |
| (inventive) | | | | | |
| O | SC510 | 50 | 0.75 | about 70% | about 5% |
| (inventive) | | | | | |

### Example 3

Three levels of 2-ethylhexyl acrylate were screened (0%, 12.5%, and 25% replacement of butyl acrylate with 2-ethylhexyl acrylate) with photo-initiator Optifilm blend (comparative) and PI-006 (comparative). As depicted in Table 4, no synergistic effect is seen in Samples F and G (Optifilm blend) and Samples I-K (PI-006) for gloss retention or dirt pick up resistance.

TABLE 4
Gloss retention after 1000 hours of QUV exposure and dirt
pick up resistance [reported as % Y (color) change]
for comparative samples of Example 3, varying in 2-ethylhexylacrylate
with Optifilm blend (F-H) and PI-006 (I-K)

| | Active | 2-EHA | Active | Gloss | % Y |
|---|---|---|---|---|---|
| Sample | Component | (wt. %) | (pts) | Retention | Change |
| F | Optifilm | 0 | 0.75 | about 55% | about 10% |
| (comparative) | blend | | | | |
| G | Optifilm | 12.5 | 0.75 | about 35% | about 5% |
| (comparative) | blend | | | | |
| H | Optifilm | 25 | 0.75 | about 45% | about 10% |
| (comparative) | blend | | | | |
| I | PI-006 | 0 | 1.25 | about 55% | about 5% |
| (comparative) | | | | | |
| J | PI-006 | 12.5 | 1.25 | about 60% | about 5% |
| (comparative) | | | | | |
| K | PI-006 | 25 | 1.25 | about 60% | about 5% |
| (comparative) | blend | | | | |

According to a first aspect of the present disclosure, a water-based composition, comprises: a latex polymer having a T_{g} from about −50° C. to about 20° C., or from about −20° C. to 20° C., or from about 0° C. to 20° C., or from about 5° C. to 20° C., or from about 8° C. to 14° C. The water-based compositions also comprises a photoinitiator component comprising a Norrish type I photoinitiator and a Norrish type II photoinitiator. The water-based compositions may comprise optionally a crosslinking component, and optionally a siloxane-based block resistance additive. The water-based composition does not contain benzophenone and does not contain methyl-o-benzoyl-benzoate.

A second aspect of the present disclosure, includes the first aspect where the photoinitiator component is present in an amount from about 0.1 wt. % to about 15 wt. %, or about 0.1 wt. % to about 10 wt. %, or about 0.3 wt. % to about 8 wt. %, preferably about 0.6 wt. % to about 4 wt. %, more preferably about 0.9 wt. % to about 3 wt. %, even more preferably about 0.7 wt. % to about 2 wt. %, based on the weight of polymer solids in the latex polymer.

A third aspect of the present disclosure, includes the first and second aspects where the photoinitiator component comprises, based on the total weight of the photoinitiator component, from 10 wt. % to 90 wt. % Norrish type I photoinitiator and from 10 wt. % to 90 wt. % Norrish type II photoinitiator.

A fourth aspect of the present disclosure includes any previous aspect or combination of aspects where a weight ratio of the Norrish type I photoinitiator to the Norrish type II photoinitiator in the photoinitiator component is from 1000:1 to 1:1000.

A fifth aspect of the present disclosure includes any previous aspect or combination of aspects where the Norrish type II photo initiator is a substituted diaryl ketone.

A sixth aspect of the present disclosure includes any previous aspect or combination of aspects where the Norrish type II photoinitiator is selected from the group consisting of 4-methylbenzophenone, 4-benzoyl-4′-methyldiphenyl sulfide, 4-phenylbenzophenone, 2-4-6 trimethylbenzophenone, 2-methylbenzophenone, a polymeric benzophenone (such as Speedcure® 7005 available from Arkema, Omnipol® BP available from IGM, Omnipol® 2702 available from IGM and Ebecryl® P39 available from Allnex), and mixtures thereof.

A seventh aspect of the present disclosure includes any previous aspect or combination of aspects where the Norrish type I photoinitiator is selected from the group consisting of 2-hydroxy-2-methyl-1-phenylpropanone, 2-hydroxyacetophenone, methyl benzoylformate, 1-hydroxycyclohexyl phenyl ketone, oligo[2-hydroxy-2-methyl-1-[4-(1-methylvinyl)phenyl]propanone]; 2,3-dihydro-6-(2-hydroxy-2-methyl-1-oxopropyl)-1,1,3-trimethyl-3-[4-(2-hydroxy-2-methyl-1-oxopropyl)phenyl]-1H-indene; 2,3-dihydro-5-(2-hydroxy-2-methyl-1-oxopropyl)-1,1,3-trimethyl-3-[4 (2-hydroxy-2-methyl-1-oxopropyl)phenyl]-1H-indene; 1-[4-(2-hydroxyethoxy)-phenyl]-2-hydroxy-2-methylpropan-1-one; ethyl phenyl(2,4,6-trimethylbenzoyl)phosphinate; and mixtures thereof.

An eighth aspect of the present disclosure includes any previous aspect or combination of aspects where the Norrish type I photoinitiator is selected from the group consisting of 2-hydroxy-2-methyl-1-phenylpropanone, 2-hydroxyacetophenone, methyl benzoylformate, 1-hydroxycyclohexyl phenyl ketone, oligo[2-hydroxy-2-methyl-1-[4-(1-methylvinyl)phenyl] propanone]; 2,3-dihydro-6-(2-hydroxy-2-methyl-1-oxopropyl)-1,1,3-trimethyl-3-[4-(2-hydroxy-2-methyl-1-oxopropyl)phenyl]-1H-indene; 2,3-dihydro-5-(2-hydroxy-2-methyl-1-oxopropyl)-1,1,3-trimethyl-3-[4-(2-hydroxy-2-methyl-1-oxopropyl)phenyl]-1H-indene; 1-[4-(2-hydroxyethoxy)-phenyl]-2-hydroxy-2-methylpropan-1-one; ethyl phenyl(2,4,6-trimethylbenzoyl)phosphinate; and mixtures thereof; and the Norrish type II photoinitiator is selected from the group consisting 4-methylbenzophenone, 4-benzoyl-4′-methyldiphenyl sulfide, 4-phenylbenzophenone, 2-4-6 trimethylbenzophenone, 2-methylbenzophenone, a polymeric benzophenone (such as Speedcure® 7005 available from Arkema, Omnipol® BP available from IGM, Omnipol® 2702 available from IGM and Ebecryl® P39 available from Allnex), and mixtures thereof.

A ninth aspect of the present disclosure includes any previous aspect or combination of aspects where the Norrish type I photoinitiator is 2-hydroxy-2-methyl-1-phenylpropanone.

A tenth aspect of the present disclosure includes any previous aspect or combination of aspects where the Norrish type II photoinitiator is 4-methylbenzophenone.

An eleventh aspect of the present disclosure includes any previous aspect or combination of aspects where the photoinitiator component comprises, based on the total weight of the photoinitiator component from 40 wt. % to 60 wt. % of 2-hydroxy-2-methyl-1-phenylpropanone and from 40 wt. % to 60 wt. % of 4-methylbenzophenone.

A twelfth aspect of the present disclosure includes any previous aspect or combination of aspects where the composition comprises a crosslinking component selected from the group consisting of a polyisocyanate, melamine, a dihydrazide (such as adipic acid dihydrazide (ADH)), hydrazine, a dihydrazone, a polyamine, silane-based crosslinkers, and mixtures or combinations thereof in an amount of between about 1 wt. % and 4 wt. %, based on the weight of the polymer solids in the water-based composition.

A thirteenth aspect of the present disclosure includes any previous aspect or combination of aspects where latex polymer is obtained by single-stage emulsion polymerization of a monomeric composition comprising one or more ethylenically unsaturated monomers selected from the group consisting of alkyl (meth)acrylates, vinyl aromatics, vinyl esters, acidic monomers, functional monomers, mono olefins, conjugated dienes, vinyl halides and combinations thereof, in particular one or more ethylenically unsaturated monomers selected from the group consisting of 2-ethylhexyl acrylate, methyl methacrylate, butyl acrylate, methacrylic acid, hydroxyethyl acrylate, styrene, alpha-methyl styrene, acrylic acid, acrylonitrile, vinyl chloride, and combinations thereof.

A fourteenth aspect of the present disclosure includes any previous aspect or combination of aspects where the latex polymer is obtained by multi-stage emulsion polymerization of a monomeric composition comprising one or more ethylenically unsaturated monomers selected from the group consisting of alkyl (meth)acrylates, vinyl aromatics, vinyl esters, acidic monomers, functional monomers, mono olefins, conjugated dienes, vinyl halides and combinations thereof, in particular one or more ethylenically unsaturated monomers selected from the group consisting of 2-ethylhexyl acrylate, methyl methacrylate, butyl acrylate, methacrylic acid, hydroxyethyl acrylate, styrene, alpha-methyl styrene, acrylic acid, acrylonitrile, vinyl chloride, and combinations thereof.

A fifteenth aspect of the present disclosure includes any previous aspect or combination of aspects where the latex polymer comprises, based on the total weight of polymer solids in the latex polymer from 0 wt. % to about 90 wt. % of 2-ethylhexyl acrylate, preferably from about 5 wt. % to about 40 wt. %, more preferably from about 10 wt. % to about 30 wt. %; from about 10 wt. % to about 90 wt. % of methyl methacrylate, preferably from about 30 wt. % to about 60 wt. %, more preferably from about 40 wt. % to about 50 wt. %; from about 10 wt. % to about 90 wt. % of butyl acrylate, preferably from about 30 wt. % to 60 wt. %, more preferably from about 40 wt. % to about 50 wt. %; from about 0.5 wt. % to about 5 wt. % of methacrylic acid, preferably from about 1 wt. % to about 3 wt. %, more preferably from about 1 wt. % to about 2 wt. %; and optionally from about 1 wt. % to about 2 wt. % of 2-(2-oxo-1-imidazolidinyl)ethyl (meth)acrylate.

A sixteenth aspect of the present disclosure includes any previous aspect or combination of aspects where the latex polymer comprises from about 10 wt. % to about 30 wt. % 2-ethylhexyl acrylate; and the photoinitiator component comprises: from about 40 wt. % to about 60 wt. % 2-hydroxy-2-methyl-1-phenylpropanone based on the total weight of the photoinitiator component; and from about 40 wt. % to about 60 wt. % of 4-methylbenzophenone based on the total weight of the photoinitiator component.

A seventeenth aspect of the present disclosure includes any previous aspect or combination of aspects where the latex polymer comprises, based on the total weight of polymer solids in the latex polymer: from about 10 wt. % to about 30 wt. % of 2-ethylhexyl acrylate, from about 40 wt. % to about 50 wt. % of methyl methacrylate; from about 40 wt. % to about 50 wt. % of butyl acrylate; from about 1 wt. % to about 2 wt. % of methacrylic acid; optionally from about and the photoinitiator component comprises, based on the total weight of the photoinitiator: from about 40 wt. % to about 60 wt. % of 2-hydroxy-2-methyl-1-phenylpropanone based on the total weight of the photoinitiator component; and from about 40 wt. % to about 60 wt. % of 4-methylbenzophenone based on the total weight of the photoinitiator component.

An eighteenth aspect of the present disclosure includes any previous aspect or combination of aspects where the water-based composition comprises, based on the total weight of the water-based composition, from about 50 wt. % to about 60 wt. % of the latex polymer; and from about 1 wt. % to about 2 wt. % of the photoinitiator component; and at least one siloxane-based block resistance additive.

A nineteenth aspect of the present disclosure includes any previous aspect or combination of aspects where the water-based composition of any preceding claim is prepared by dissolving the Norrish type II photoinitiator as a solid in the Norrish type I photoinitiator as a liquid to obtain a photoinitiator component; and mixing the photoinitiator component and the latex polymer to obtain the water-based composition.

A twentieth aspect of the present disclosure includes the nineteenth aspect, where the photoinitiator component is a eutectic mixture of the Norrish type II photoinitiator and the Norrish type I photoinitiator.

A twenty-first aspect of the present disclosure includes the nineteenth and twentieth aspects, where the photoinitiator component is a homogenous liquid mixture of the Norrish type II photoinitiator and the Norrish type I photoinitiator.

A twenty-second aspect of the present disclosure includes any previous aspect or combination of aspects, where the water-based composition further comprises at least one of the following: pigment(s), thickener(s), defoamer(s), mildewcide(s), biocide(s), dispersant(s), surfactant(s), filler(s), and combinations thereof.

A twenty-third aspect of the present disclosure includes any previous aspect or combination of aspects, where the composition is a paint, sealant, sealer, or caulk.

A twenty-fourth aspect of the present disclosure includes any previous aspect or combination of aspects, where the composition is a paint.

A twenty-fifth aspect of the present disclosure includes any previous aspect or combination of aspects, where the composition is a sealant.

A twenty-sixth aspect of the present disclosure includes any previous aspect or combination of aspects, where the composition is a sealer.

A twenty-seventh aspect of the present disclosure includes any previous aspect or combination of aspects, where the composition is a caulk.

A twenty-eighth aspect of the present disclosure includes any previous aspect or combination of aspects where the water-based composition is used in the formulation of a water-based paint, a sealer, a caulk, or a sealant.

It will be apparent to persons of ordinary skill in the art that various modifications and variations may be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment.

1. A water-based composition, comprising:
a latex polymer having a T_{g} from about −50° C. to about 20° C.;
a photoinitiator component comprising a Norrish type I photoinitiator and a Norrish type II photoinitiator;
optionally, a crosslinking component; and
optionally, a siloxane-based block resistance additive,
wherein the water-based composition does not contain benzophenone and does not contain methyl-o-benzoyl-benzoate.

2. The water-based composition of claim 1, wherein the photoinitiator component is present in an amount from about 0.1 wt. % to about 15 wt. % based on a total weight of polymer solids in the latex polymer.

3. The water-based composition of claim 1, wherein the photoinitiator component comprises, based on a total weight of the photoinitiator component:
from 10 wt. % to 90 wt. % of the Norrish type I photoinitiator; and
from 10 wt. % to 90 wt. % of the Norrish type II photoinitiator.

4. The water-based composition of claim 1, wherein a weight ratio of the Norrish type I photoinitiator to the Norrish type II photoinitiator in the photoinitiator component is from 1000:1 to 1:1000.

5. The water-based composition of claim 1, wherein the Norrish type II photo initiator is a substituted diaryl ketone.

6. The water-based composition of claim 1, wherein the Norrish type II photoinitiator is selected from the group consisting of 4-methylbenzophenone, 4-benzoyl-4′-methyldiphenyl sulfide, 4-phenylbenzophenone, 2,4,6-trimethylbenzophenone, 2-methylbenzophenone, a polymeric benzophenone, and mixtures thereof.

7. The water-based composition of claim 1, wherein the Norrish type I photoinitiator is selected from the group consisting of:
2-hydroxy-2-methyl-1-phenylpropanone,
2-hydroxyacetophenone, methyl benzoylformate,
1-hydroxycyclohexyl phenyl ketone,
oligo[2-hydroxy-2-methyl-1-[4-(1-methylvinyl)phenyl]propanone],
2,3-dihydro-6-(2-hydroxy-2-methyl-1-oxopropyl)-1,1,3-trimethyl-3-[4-(2-hydroxy-2-methyl-1-oxopropyl)phenyl]-1H-indene,
2,3-dihydro-5-(2-hydroxy-2-methyl-1-oxopropyl)-1,1,3-trimethyl-3-[4-(2-hydroxy-2-methyl-1-oxopropyl)phenyl]-1H-indene,
1-[4-(2-hydroxyethoxy)-phenyl]-2-hydroxy-2-methylpropan-1-one,
ethyl phenyl(2,4,6-trimethylbenzoyl)phosphinate, and
mixtures thereof.

8. The water-based composition of claim 1, wherein:
the Norrish type I photoinitiator is selected from the group consisting of:
2-hydroxy-2-methyl-1-phenylpropanone,
2-hydroxyacetophenone,
methyl benzoylformate,
1-hydroxycyclohexyl phenyl ketone,
oligo[2-hydroxy-2-methyl-1-[4-(1-methylvinyl)phenyl]propanone];
2,3-dihydro-6-(2-hydroxy-2-methyl-1-oxopropyl)-1,1,3-trimethyl-3-[4-(2-hydroxy-2-methyl-1-oxopropyl)phenyl]-1H-indene;
2,3-dihydro-5-(2-hydroxy-2-methyl-1-oxopropyl)-1,1,3-trimethyl-3-[4-(2-hydroxy-2-methyl-1-oxopropyl)phenyl]-1H-indene;
1-[4-(2-hydroxyethoxy)-phenyl]-2-hydroxy-2-methylpropan-1-one;
ethyl phenyl(2,4,6-trimethylbenzoyl)phosphinate, and
mixtures thereof; and
the Norrish type II photoinitiator is selected from the group consisting of:
4-methylbenzophenone,
4-benzoyl-4′-methyldiphenyl sulfide,
4-phenylbenzophenone,
2,4,6-trimethylbenzophenone,
2-methylbenzophenone,
a polymeric benzophenone, and
mixtures thereof.

9. The water-based composition of claim 1, wherein the Norrish type I photoinitiator is 2-hydroxy-2-methyl-1-phenylpropanone.

10. The water-based composition of claim 1, wherein the Norrish type II photoinitiator is 4-methylbenzophenone.

11. The water-based composition of claim 1, wherein the photoinitiator component comprises, based on the total weight of the photoinitiator component:
from 40 wt. % to 60 wt. % of the Norrish type I photoinitiator, which is 2-hydroxy-2-methyl-1-phenylpropanone; and
from 40 wt. % to 60 wt. % of the Norrish type II photoinitiator, which is 4-methylbenzophenone.

12. The water-based composition of claim 1, wherein the composition comprises the crosslinking component, wherein the crosslinking component is selected from the group consisting of diacetone acrylamide (DAAM), adipic acid dihydrazide (ADH), acetoacetoxyethyl methacrylate (AAEM); silane-based crosslinkers, 1,6-hexanediol diacrylate (HDDA), and mixtures or combinations thereof in an amount of between about 1 wt. % and 4 wt. %, based on a total weight of the polymer solids in the water-based composition.

13. The water-based composition of claim 1, wherein the latex polymer is derived by polymerization in a single stage of an emulsion of one or more ethylenically unsaturated monomers selected from the group consisting of alkyl acrylates, alkoxy acrylates, alkyl methacrylates, alkoxy methacrylates, vinyl esters of saturated carboxylic acids, mono olefins, conjugated dienes, 2-ethylhexyl acrylate, methyl methacrylate, butyl acrylate, methacrylic acid, hydroyethyl acrylate, styrene, alpha-methyl styrene, acrylic acid, acrylonitrile, vinyl chloride, and combinations thereof.

14. The water-based composition of claim 1, wherein the latex polymer is derived by polymerization in a multi-stage of an emulsion of one or more ethylenically unsaturated monomers selected from the group consisting of alkyl acrylates, alkoxy acrylates, alkyl methacrylates, alkoxy methacrylates, vinyl esters of saturated carboxylic acids, mono olefins, conjugated dienes, 2-ethylhexyl acrylate, methyl methacrylate, butyl acrylate, methacrylic acid, hydroyethyl acrylate, styrene, alpha-methyl styrene, acrylic acid, acrylonitrile, vinyl chloride, and combinations thereof.

15. The water-based composition of claim 1, wherein the latex polymer comprises, based on a total weight of polymer solids in the latex polymer:
from 0 wt. % to about 90 wt. % of 2-ethylhexyl acrylate;
from about 10 wt. % to about 90 wt. % of methyl methacrylate;
from about 10 wt. % to about 90 wt. % of butyl acrylate;
from about 0.5 wt. % to about 5 wt. % of methacrylic acid; and
optionally, from about 1 wt. % to about 2 wt. % of 2-(2-oxo-1-imidazolidinyl)ethyl (meth)acrylate.

16. The water-based composition of claim 1, wherein:
the latex polymer comprises from about 10 wt. % to about 30 wt. % of 2-ethylhexyl acrylate, based on a total weight of polymer solids in the latex polymer; and
the photoinitiator component comprises:
from about 40 wt. % to about 60 wt. % of
2-hydroxy-2-methyl-1-phenylpropanone based on a total weight of the photoinitiator component; and
from about 40 wt. % to about 60 wt. % of 4-methylbenzophenone based on the total weight of the photoinitiator component.

17. The water-based composition of claim 1, wherein:
the latex polymer comprises, based on the total weight of polymer solids in the latex polymer:
from about 10 wt. % to about 30 wt. % of 2-ethylhexyl acrylate;
from about 40 wt. % to about 50 wt. % of methyl methacrylate;
from about 40 wt. % to about 50 wt. % of butyl acrylate;
from about 1 wt. % to about 2 wt. % of methacrylic acid;
optionally, from about 1 wt. % to about 2 wt. % of
2-(2-oxo-1-imidazolidinyl)ethyl (meth)acrylate; and
the photoinitiator component comprises, based on the total weight of the photoinitiator:
from about 40 wt. % to about 60 wt. % of
2-hydroxy-2-methyl-1-phenylpropanone based on the total weight of the photoinitiator component; and
from about 40 wt. % to about 60 wt. % of 4-methylbenzophenone based on the total weight of the photoinitiator component.

18. The water-based composition of claim 1, wherein the water-based composition comprises, based on a total weight of the water-based composition:
from about 50 wt. % to about 60 wt. % of the latex polymer; and
from about 1 wt. % to about 2 wt. % of the photoinitiator component; and
at least one siloxane-based block resistance additive.

19. The water-based composition of claim 1, prepared by:
dissolving the Norrish type II photoinitiator as a solid in the Norrish type I photoinitiator as a liquid to obtain the photoinitiator component; and
mixing the photoinitiator component and the latex polymer to obtain the water-based composition.

20. The water-based composition of claim 1, further comprising at least one of the following: pigment(s), thickener(s), defoamer(s), mildewcide(s), biocide(s), dispersant(s), surfactant(s), filler(s), and combinations thereof.

21. The water-based composition of claim 1, wherein the composition is a paint, sealant, sealer, or caulk.
